(19) United States
(12) Patent Application Publication
(10) Pub. No.: US 2016/0037167 A1
(43) Pub. Date: Feb. 4, 2016

(54) METHOD AND APPARATUS FOR DECODING A VARIABLE QUALITY BITSTREAM

(71) Applicant: ANHUI GUANGXING LINKED-VIDEO COMMUNICATION TECHNOLOGY CO. LTD, Hefei, Anhui (CN)

(72) Inventors: Jiangtao WEN, La Jolla, CA (US); Shunyao LI, Goleta, CA (US); Yao LU, La Jolla, CA (US)

(21) Appl. No.: 14/781,327

(22) PCT Filed: Mar. 28, 2014
(86) PCT No.: PCT/US2014/032242

§ 371 Date: Sep. 30, 2015

Related U.S. Application Data
(60) Provisional application No. 61/853,153, filed on Mar. 30, 2013.

(51) Int. Cl. H04N 19/139; H04N 19/172; H04N 19/44

(52) U.S. Cl. CPC H04N 19/139; H04N 19/44; H04N 19/172

(57) ABSTRACT

A video decoder may improve the quality of video decoded from a video bitsteam with time-varying visual quality. The decoder uses information available to the decoder from an independently encoded high quality segment of the video that has been decoded. The information from the previously decoded segment may be used to enhance an initial frame of the lower quality segment.

### CROSS-REFERENCE TO RELATED APPLICATIONS

This application claims priority to U.S. Provisional Application Ser. No. 61/853,153 filed Mar. 30, 2013, the entire contents of which are incorporated herein by reference in their entirety.

### TECHNICAL FIELD

The current disclosure relates to decoding video bitstreams and in particular to improving the quality of decoded video bitstreams of varying quality.

### BACKGROUND

Video can be encoded using different techniques. The encoded video may then be transmitted to a receiving device using a communication channel and the encoded video can be decoded and displayed. The encoding and decoding process may provide a tradeoff between complexity of encoding, complexity of decoding, quality of the decoded video, size of the encoded video, memory requirements for encoding and memory requirements for decoding. For example, the same video may be encoded to produce two different size encoded video files having the same visual quality, with the smaller sized video being more complex to encode and/or decode.

When streaming videos, for example over a network, videos may be encoded as individual video clips or segments that can each be independently decoded and stitched together into a single video. Each segment may be encoded a number of times to produce different quality versions of the segment. The appropriate segment quality for transmission may be selected based on prevailing network conditions. For example, if there is sufficient network bandwidth available, a high quality segment may be transmitted. As the network bandwidth decreases, it may no longer be possible to playback the video at the high quality without buffering, and as such the next segment may be transmitted at the lower quality.

It is desirable to have an additional, alternative and/or improved decoder capable of potentially improving a decoded video quality of videos having a time-varying quality.

### BRIEF DESCRIPTION OF THE DRAWINGS

Features, aspects and advantages of the present disclosure will become better understood with regard to the following description and accompanying drawings in which:

FIG. 1 depicts an overview of an environment in which video may be decoded;

FIG. 2 depicts components of a video;

FIG. 3 depicts the transmission of video segments;

FIG. 4 depicts decoding of a video segment;

FIG. 5 depicts a method of decoding a video segment;

FIG. 6 depicts combining portions of a higher quality video frame and a lower quality video frame together;

FIG. 7 depicts a further method of decoding a video segment;

FIG. 8 depicts a portion of a further method of decoding a video segment;

FIG. 9 depicts a further portion of the method of FIG. 8; and

FIG. 10 depicts the relationship between the values of Th_{Opt} and the PSNR of the SF after intra encoding;

FIG. 11 depicts the relationship between the values of Th_{Opt} and the MECost;

FIG. 12 depicts a plot of the relationship between the values of Th_{MSD} and the Average Sum of Absolute Differences (AvgSAD) between the decoded GF and SF referenced by the calculated MVs (AvgSAD) with different QP values of the decoded SF; and

FIG. 13 an apparatus for decoding video.

### DETAILED DESCRIPTION

In accordance with the present disclosure, there is provided a method of decoding a variable quality video bitstream comprising: decoding a current frame of a current segment of the video bitstream having a first video quality; combining the decoded current frame and a decoded previous frame of an temporally previous segment of the video bitstream into an enhanced current frame, the temporally previous segment of the video bitstream having a second video quality higher than the first video quality; and decoding remaining frames of the current segment of the video bitstream using the enhanced current frame.

In an embodiment combining the decoded current frame and the decoded previous frame comprises: segmenting the decoded current frame into a plurality of non-overlapping patches; and for each patch: calculating a difference between at least a portion of the patch and a corresponding portion of the decoded previous frame; and copying the corresponding portion of the decoded previous frame to the current frame when the difference is less than a threshold.

In an embodiment combining the decoded current frame and the decoded previous frame comprises: identifying high motion areas and low motion areas between the previous frame and the current frame; copying at least a first portion of the decoded previous frame to at least a co-located portion of the low motion areas of the decoded current frame according to a first combination process; and copying at least a second portion of the decoded previous frame to at least a corresponding portion of the high motion areas of the decoded current frame according to a second combination process.

In an embodiment identifying high motion areas and low motion areas comprises: determining motion vectors between the decoded previous frame and the decoded current frame using motion estimation; segmenting the decoded current frame into a plurality of non-overlapping patches; and marking each of the plurality of patches as either a low motion patch or a high motion patch based on the motion vectors of the patch.

In an embodiment marking each of the plurality of patches comprises for each patch: averaging together the motion vectors of the respective patch to provide a patch motion vector; marking the patch as a low motion patch if the patch motion vector is less than an motion vector threshold; and marking the patch as a high motion patch if the patch motion vector is greater than or equal to the motion vector threshold.

In an embodiment the first combination process comprises: determining a difference between at least the first portion of the decoded previous frame and at least the co-located portion of the low motion areas of the current frame; copying at least the first portion of the decoded previous frame to at least the co-located portion of the low motion areas of the decoded current frame when the difference is below a threshold.

In an embodiment, the method further comprises: segmenting the low motion areas of the decoded current frame into a plurality of non-overlapping pixel patches; and for each pixel patch: determining a difference between the pixel patch and a co-located pixel patch in the decoded previous frame; and copying the co-located pixel patch from the decoded previous frame to the pixel patch of the decoded current frame when the determined difference is below a threshold.

In an embodiment the difference is determined using one of: a mean square difference; and a sum of squared differences.

In an embodiment the second combination process comprises: determining a difference between at least the second corresponding portion of the decoded previous frame and at least the corresponding portion of the high motion areas of the current frame; copying at least the first corresponding portion of the decoded previous frame to at least the portion of the low motion areas of the decoded current frame when the difference is below a threshold.

In an embodiment the second combination process further comprises: segmenting the high motion areas of the current frame into a plurality of patches; and for each patch: determining a number (N_{match}) of neighboring patches having matching motion vectors to the current patch; when N_{match} is more than a threshold, for each pixel p of the current patch: determine a corresponding pixel p′ in the decoded previous frame referenced by the motion vector of the current patch; and copying the pixel p′ to p if |p−p′|<a threshold.

In an embodiment the second combination process further comprises: segmenting the high motion areas of the current frame into a plurality of patches; and for each patch: determining a number (N_{match}) of neighboring patches having matching motion vectors to the current patch; when N_{match} is more than a threshold, determining a corresponding pixel patch P′ in the decoded previous frame referenced by the motion vector of the current patch; and copying the pixel patch P′ to the current patch P if the mean square differences (MSD) between P and P′<a threshold.

In an embodiment, the segmenting uses a patch size based on the video.

In an embodiment, the method further comprises determining the patch size by: reducing a patch size from a starting patch size and determining a variance of motion vectors of the patch size until the variance is larger than a threshold value.

In an embodiment combining the decoded current frame and the decoded previous frame comprises copying at least a portion of the decoded previous frame to the decoded current frame.

In an embodiment at least the portion of the decoded previous frame copied to the decoded current frame is processed to adjust at least one image characteristic prior to copying to the decoded current frame.

In an embodiment combining the decoded current frame and the decoded previous frame comprises combining the decoded current frame, the decode previous frame and at least one other decoded frame of the temporally previous segment of the video bitstream.

In an embodiment, the method further comprises: decoding an additional frame of the current segment of the video bitstream; and combining the decoded further frame with at least one decoded frame from the temporally previous segment to provide an enhanced additional frame.

In an embodiment the decoded previous frame combined with the decoded current frame is visually similar to the decoded current frame.

In an embodiment, the method further comprises: determining at least one frame from a plurality of frames of the temporally previous segment to use as the decoded previous frame based on a similarity to the decoded current frame.

In an embodiment, the method further comprises: decoding the immediately previous segment of the video bitstream prior to decoding the current frame of the current segment of the video bitstream.

In an embodiment the variable quality video bitstream comprises a plurality of temporal video segments, including the current segment and the temporally previous segment, each having a respective video quality.

In an embodiment each of the video segments comprises at least one intra-coded video frame that can be independently decoded and at least one inter-coded video frame that is decoded based on at least one other video frame of the video segment.

In accordance with the present disclosure, there is further provided an apparatus for decoding video comprising: a processor for executing instructions; and a memory for storing instructions, which when executed by the processor configure the apparatus to perform a method of a method of decoding a variable quality video bitstream.

In accordance with the present disclosure, there is further provided a non-transitory computer readable medium storing executable instructions for configuring an apparatus to perform a method of a method of decoding a variable quality video bitstream.

A decoder is described that uses information from a high visual quality independently encoded segment that has already been received and decoded when decoding a subsequent lower quality independently encoded segment. The decoder may improve a Quality of Experience (QoE) without incurring significant delays or additional overhead of storage and computational complexity of both the encoder and decoder, or loss of coding efficiency.

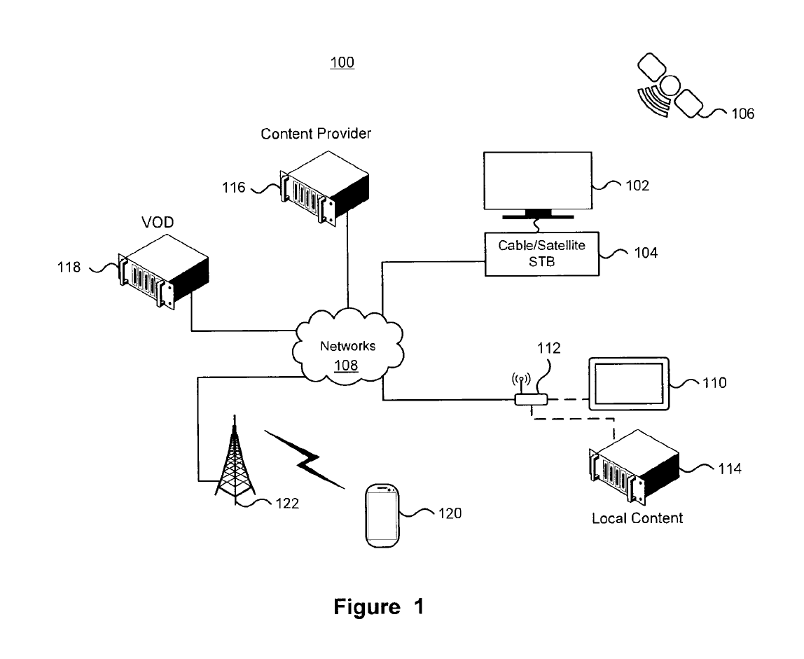

FIG. 1 depicts an overview of an environment 100 in which video may be decoded. Video content may be recorded or generated and then encoded for distribution to various devices for consumption. For example, a television 102 may be connected to a cable or satellite set top box (STB) 104 that receives video content from a satellite 106 or cable TV network 108. The STB 104 receives encoded video content, decodes it and provides it to the TV for display. Additionally or alternatively, the television 102 itself may include a decoder capable of receiving the encoded video content and decoding it for display. Video content may further be displayed on other devices, such as a tablet 110 or portable computer. The tablet 110 may be used in a local network 112 to access local video content 114, such as stored videos. The local network 112 may be coupled to other networks 108, which allow the tablet to access other video content that may be provided by network content providers 116 and or video-on-demand (VOD) services 118. Further, although not depicted in the environment 100, the tablet may also receive video content from other computing devices, either on the same local network 112 or connected to the internet 108, for example in a voice call, or for video sharing. Video content may also be streamed to or from mobile devices 120, such as smartphones or tablets, over a cellular network 122.

As depicted in FIG. 1, the environment in which video content may be streamed to a device is varied. The bandwidth available for streaming video content to a particular device may vary over time. Similarly, the bandwidth available for streaming content to different devices may vary from device to device. In order to provide acceptable video content streaming in the environment 100, video content may be encoded at varying qualities, for example high, medium and low, and the appropriate encoding may be selected for streaming to the device based on the bandwidth available for streaming. Additionally or alternatively, the video may be encoded atone setting and the video quality may vary over time.

One possible technique to adapt to changing network conditions while streaming video content, is to split a single video into a number of consecutive segment, which may then be independently encoded at different quality level settings. The quality may then be varied for each segment, allowing the streaming quality to be adjusted based on prevailing network conditions. Each segment may vary in length, although typical segment lengths may be, for example, anywhere from between 1 second and 10 seconds. So for example, a minute long video may be encoded into 18 different encodings, such as a high quality encoding, a medium quality encoding and a low quality encoding for each of six 10 second segments. When streaming the video, the high quality version for the first 30 seconds, that is for the first three segments, may be streamed, however if the network quality degrades, the next segment may be streamed at the medium quality encoding. If the network quality continues to degrade, the last two segments may be streamed at the lowest quality encoding. Accordingly, the video will be streamed for 30 seconds at high quality, 10 seconds at medium quality and 20 seconds at low quality.

As described further below, when decoding a segment that is of a lower quality than the previous segment, the decoder may use information from the previous higher quality segment in order to improve the decoded quality of the lower quality segment.

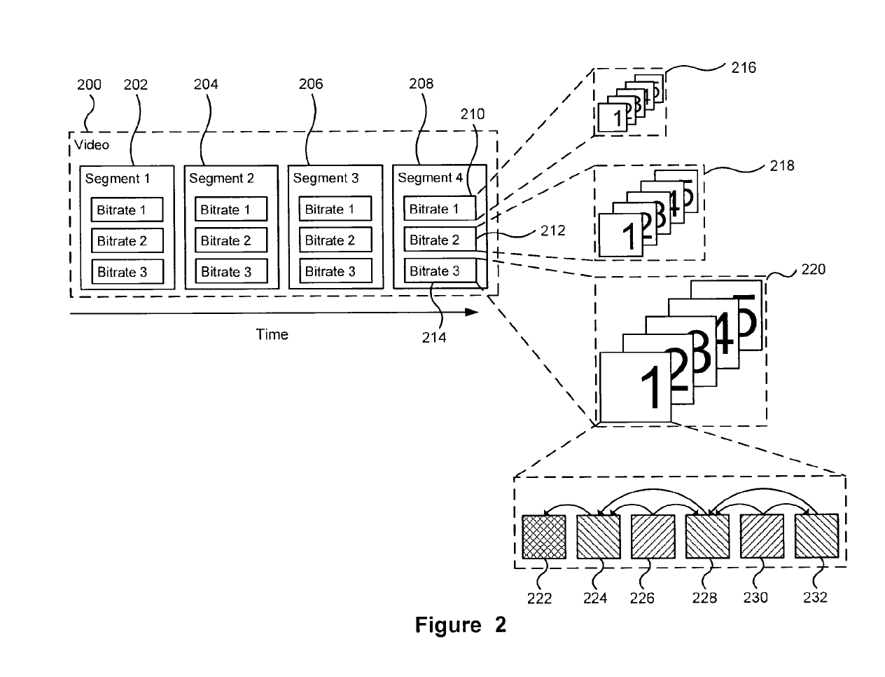

FIG. 2 depicts components of a video for network streaming. The video 200 may be any video content that has been encoded. In FIG. 2 it is assumed that the video content has been encoded for streaming over a network. The video 200 is composed of a number of segments 202, 204, 206, 208. Each segment 202, 204, 206, 208 may encode the same length of video, such as between 1 and 10 seconds. Alternatively, the segments may be of varying lengths. Regardless of the particular length of the individual segments, the segments can be decoded and then stitched together to provide the entire video 200.

Once the video is split into the segments 202, 204, 206, 208, each segment is encoded to provide the different quality encodings, depicted as ‘Bitrate 1’, ‘Bitrate 2’ and ‘Bitrate 3’, or which bitrate encodings 210, 212, 214 are detailed further for segment 4 208. Although the following refers the to bitrate encodings 210, 212, 214 of segment 4 208 it will be appreciated that the bitrate encodings for the other segments, 202, 204, 206 have a similar structure. Each of the bitrate encodings 210, 212, 214 comprises one or more group of pictures (GOP) 216, 218, 220 that encode the same frames of video at the different qualities. Each bitrate encoding is depicted as comprising 5 different GOPs. Bitrate 1 encoding 210 is of the lowest quality, bitrate 2 encoding 212 is of medium quality, and bitrate 3 encoding 214 is of the highest quality, as depicted by the relative size of the GOPs 216, 218, 220. It will be appreciated that the actual display size of a decoded video of the different bitrates may be the same.

As depicted for GOP 220, each GOP comprises a number of frames of the video 222, 224, 226, 228, 230, 232. The first frame 222 of each GOP can be decoded without reference to any other frames, and may be referred to as an intra-coded frame. The remaining frames are decoded with reference to one or more of the other frames in the GOP. For example the first frame 222 may be decoded first, followed by the second frame 224, which depends only from the first frame. The fourth frame 228, which depends only from the first frame may be decoded next, followed by the third frame 226 which depends from both the second frame 224 and the fourth frame 228. The sixth frame 232 is then decoded based on the fourth frame 228, and then the fifth frame 230 is decoded with reference to the fourth frame 228 and the sixth frame 232. As described further below, by improving the quality of a decoded reference frame used in decoding other frames, such as the first decoded frame 222, prior to decoding the remaining frames of the GOP, it is possible to improve the quality of the decoded segment. For example, the quality of the first decoded frame 222 may be improved using information from the last decoded frame of the immediately previous segment if that segment was of a higher quality than the current segment. The enhanced decoding does not require extensive modifications to the encoding process.

By extracting information contained in such a segment that is available to the decoder but was not taken advantaged by the encoder, the decoder is capable of improving the QoE of the user without incurring significant overhead to the storage and computational complexities of both the encoder and the decoder, or introducing significant delays or losses to coding efficiency.

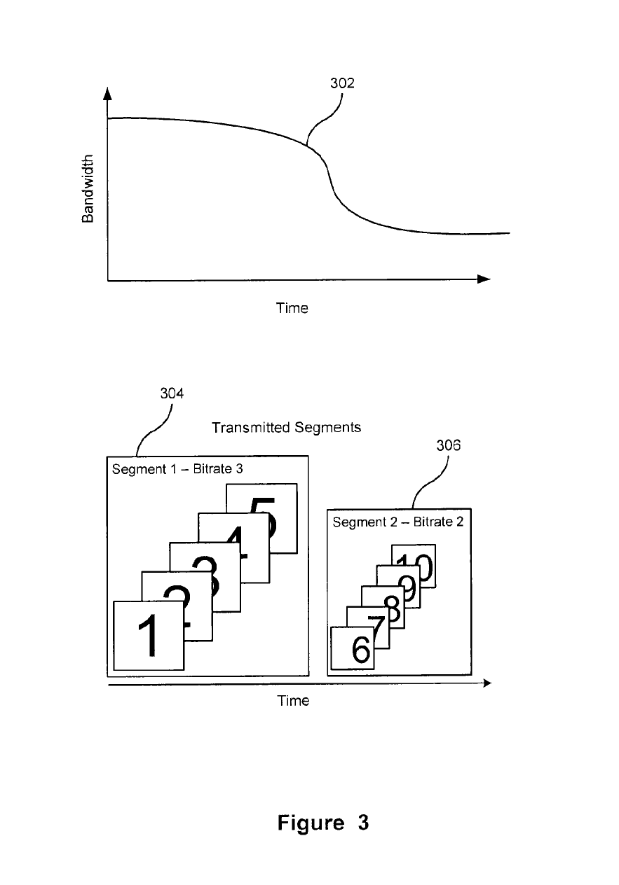

FIG. 3 depicts the transmission of video segments. As depicted, the bandwidth 302 for streaming a video may vary over time. When the video begins streaming, the bandwidth is sufficient to support transmission of the high quality bitrate encoding for the first segment 304. As the first segment is being streamed, the available bandwidth 302 may degrade, and as such, when the second segment is required to be streamed, a lower quality bitrate encoding 304 is transmitted. Accordingly, the streaming device may “stitch” together bitstreams for temporally neighboring segments that have been independently encoded at different resulting in variations of video quality over time. Such variations in visual quality may impair the user QoE.

Although the above has described the quality variations as being a result of streaming different bitrate encodings, similar variations in visual quality may also occur as a result of an encoder with a rate allocation algorithm that is not able to allocate the target bitrate in a globally optimized manner over the entire clip. This may be due to the lack of multiple pass encoding (e.g. for encoding live events) or sufficient look ahead (due to memory or delay requirements), and/or when the complexity of the input video varies significantly over time. Accordingly, when encoding segments of the video, the encoding of one segment may result in a higher or lower quality of video than the previous or subsequent segment. As such, when decoding a current segment, the previously decoded segment may be of a higher quality. The decoding of the current segment may benefit by enhancing a decoded frame of the current segment using information from the previous higher quality segment, prior to decoding the remaining frames of the segment.

When the visual quality of an input bitstream to a video decoder as described herein varies over time, at the transition from a segment with higher video quality to a temporally neighboring independently encoded segment of lower quality, last frame in display order in the higher quality segment may be referred to as a “good frame” (GE), the first intra-coded frame of the poor quality segment may be referred to as a “start frame” (SF), and the enhanced first frame used for subsequent decoding of the poor quality segment may be referred to as a “fresh start” (FS). It is noted that the SF as an intra-coded frame, was encoded without reference to the GF or any other frames in the higher quality segment.

The goal of the enhancement algorithm is to use information contained in the GF to improve the quality of the decoded SF to get an improved reference frame FS for subsequent frames in the low quality segment. Depending on the level of motion for different spatial regions of the SF, two enhancement algorithms might be used by the decoder, one for relatively low motion areas, the other for the higher motion areas. For both algorithms, the decoder will look for matches between areas in the decoded GF and the SF, as determined by a distortion metric and a threshold calculated by the decoder.

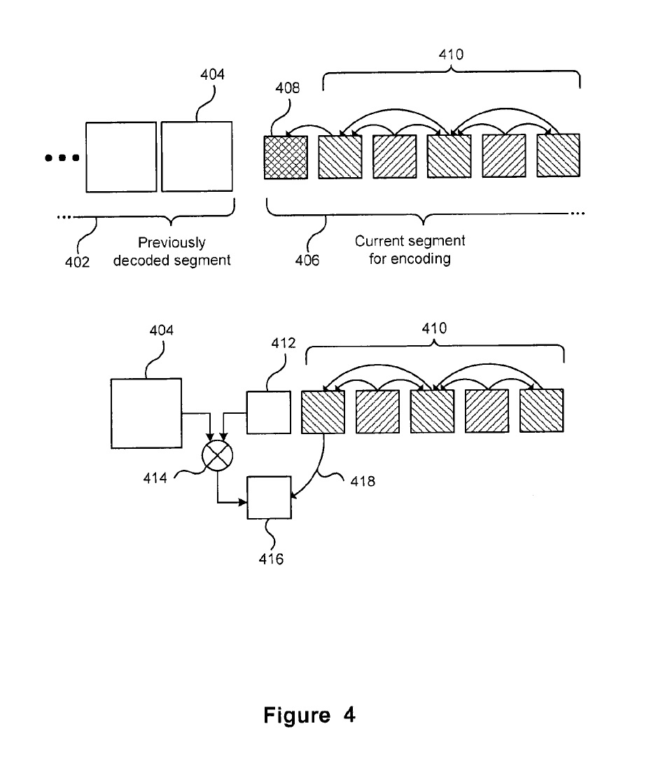

FIG. 4 depicts decoding of a video segment. In FIG. 4 a high quality video segment 402 has been received and decoded. The decoder maintains the decoded last frame of the high quality video segment, referred to as GF. A second segment 406 is received that is encoded, and decodable, independently from the high quality segment 402 and that has a lower quality. The segment 406 comprises a number of frames, including a first intra-coded frame 408, referred to as SF, that can be decoded independently from other frames and a number of inter-coded frames 410 that can be decoded with reference to other decoded frames as depicted by the arrows.

When decoding the lower quality segment 406, the first intra-coded frame 408 is decoded and the quality of the decoded frame 412 enhanced. The decoded frame 412 is enhanced by combining the frame 412 with the last frame of the high quality segment, GF 404 according to a combination process 414. The combination process 414 may copy one or more portions from the last frame of the high quality segment, GF 404, to the decoded first frame 412 to produce an enhanced first frame 416, used as a fresh start for the decoding process. The remaining frames 410 of the segment are decoded; however, with reference to the enhanced first frame 416 instead of the decoded first frame 412 as depicted by arrow 418.

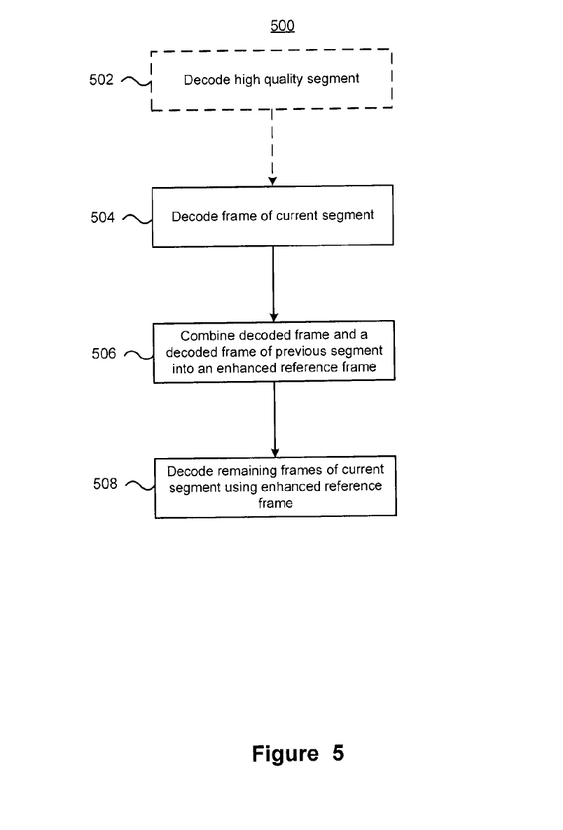

FIG. 5 depicts a method of decoding a video segment. The method 500 has already decoded a high quality segment (502) and received a lower quality segment. A current frame of the lower quality segment, which is an intra-coded frame, is decoded (504). Once the current frame is decoded, its quality is enhanced by combining at least a portion of a decoded previous frame of the higher quality segment with at least a portion of the decoded current frame (506). Once the current frame has been enhanced, the remaining frames of the lower quality segment can be decoded using the enhanced frame (506). By decoding the low quality segment based on the enhanced frame, the quality of the decoded video segment may be enhanced.

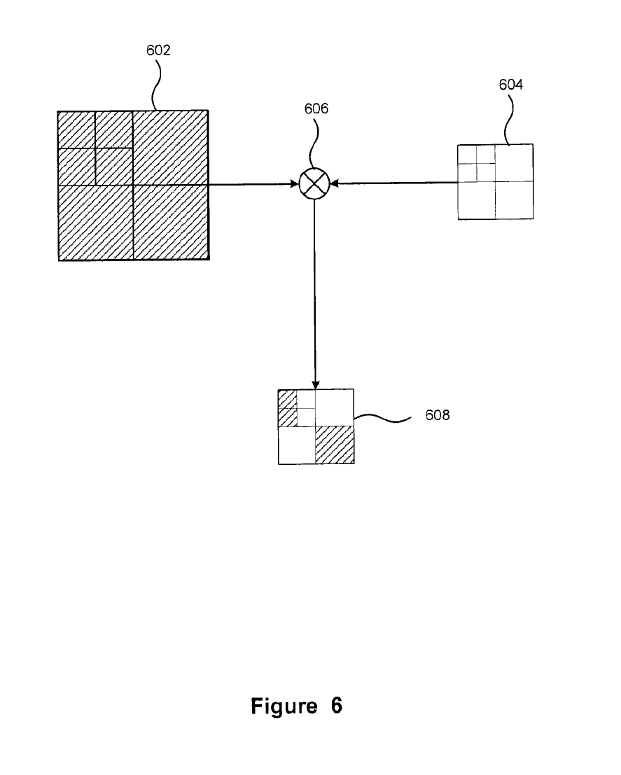

FIG. 6 depicts a representation of combining portions of a higher quality video frame and a lower quality video frame together. A decoded last frame 602 of a high quality segment and a decoded first frame 604 of a lower quality segment are combined together by the combination process 606 to generate the enhanced first frame 608. The first frame 604 may be segmented into a number of patches as depicted. The patches of the first frame may be compared to corresponding patches in the decoded last frame 602. Although the patches of the decoded last frame are depicted as being in the same location as in the decoded first frame 604, it is noted that the corresponding patches may not be co-located. If there is motion between the two frames, the corresponding patches may be displaced from each other in the two frames. Based on the comparison of the corresponding patches, it may be determined that one or more of the patches from the high quality segment should be copied to the corresponding location of the decoded first frame to provide the enhanced first frame 608. As depicted, the enhanced first frame 608 is a combination of three patches from the high quality decoded last frame 602 and four patches from the lower quality decoded first frame 604.

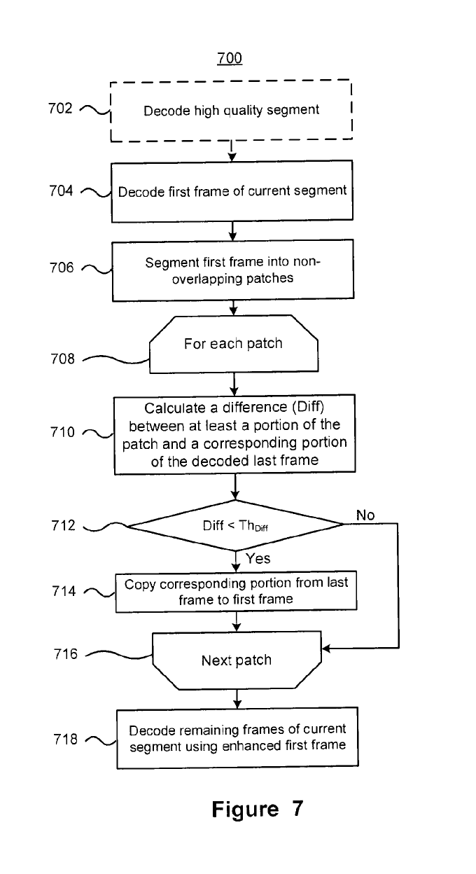

FIG. 7 depicts a further method of decoding a video segment. The method 700 has already decoded a high quality segment (702) and received a lower quality segment. The first frame of the lower quality segment is decoded (704) and the decoded first frame is segmented into a number of non-overlapping patches (706). The segmenting may use a predetermined patch size, such as for example 4×4 pixels, 8×8 pixels, 16×16 pixels or 32×32 pixels. Other patch sizes are possible and the patch sizes do not need to be squares, nor does each patch size need to be the same. Further, it is possible for the segmenting to use a dynamically calculated patch size that can be determined based on the decoded first frame.

Once the decoded first frame is segmented into a plurality of patches, each patch is processed (708). For each patch, a difference (Diff) between at least a portion of the patch and a corresponding portion of the decoded last frame can be calculated (710). The portion of the decoded last frame corresponding to at least the portion of the patch the difference is calculated for may be co-located or may be in a different location based on motion between the decoded last frame and the decoded first frame. With the difference calculated, it is determined if the calculated difference is below a threshold (Th_{Diff}) (712). If the difference is not below the threshold (No at 712) the next patch (716) is processed. If the calculated difference is below the threshold (Yes at 712), the corresponding patch from the decoded last frame of the high quality segment is copied to the patch of the decoded first frame of the low quality segment (714) and the next patch processed (716). Once all of the patches have been processed, the remaining frames of the low quality segment are decoded based on the enhanced first frame (718).

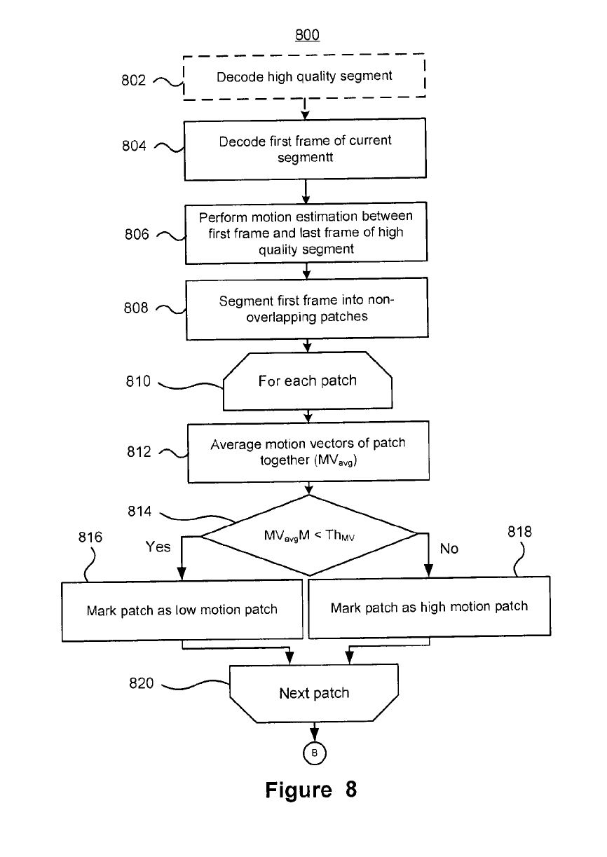

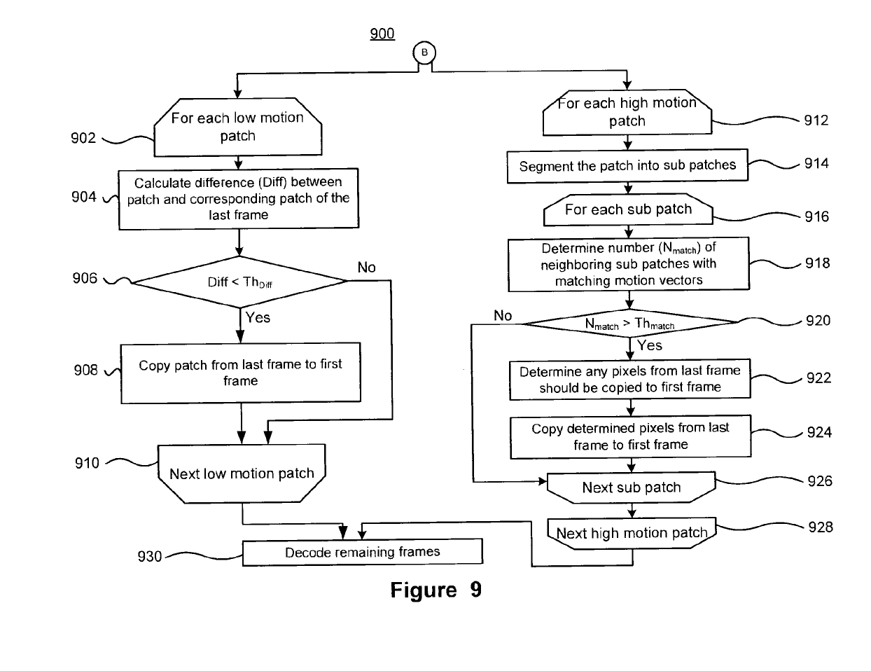

FIG. 8 depicts a portion of a further method of decoding a video segment. In particular FIG. 8 depicts a method of identifying high and low motion areas. The method 800 identifies high and low motion area between two frames, allowing different combining processes to be used for the different areas, as described further with reference to FIG. 9. The method 800 has already decoded a high quality segment (802) and received a lower quality segment. The first frame of the lower quality segment is decoded (804) and then motion estimation is performed to determine motion vectors between the decoded last frame of the high quality segment and the decoded first frame of the low quality segment (806). The decoded first frame is segmented into a number of non-overlapping patches (808). Each patch is processed in order to identify the patch as either a high motion patch or a low motion patch. For each patch (810) the motion vectors of the patch are averaged together (812) and it is determined if the average motion vector (MV_{avg}) is less than a threshold (814). If MV_{avg} is less than the threshold (Th_{MV}) (Yes at 814) the patch is marked as a low motion patch (816). If MV_{avg} is greater than or equal to the threshold Th_{MV} (No at 814) the patch is marked as a high motion patch (818). The next patch is processed (820). Once all of the patches are processed, each patch will be identified as either a high motion patch or a low motion patch. As described further with reference to FIG. 9, the low motion patches and high motion patches can be combined with the decoded last frame using different combination processes.

FIG. 9 depicts the processing of low motion patches and high motion patches. The high and low motion patches may be identified as describe above with reference to FIG. 8. The patches may be processed in parallel, or may be processed sequentially. For each of the low motion patches (902) a difference between the patch and a co-located patch in the decoded last frame is determined (904). It is determined if the difference is less than a threshold (906) and if it is (Yes at 906) the co-located patch is copied from the decoded last frame to the decoded first frame (908) and the next low motion patch is processed (910). If the difference is greater than or equal to the threshold (No at 906) the next low motion patch is processed (910).

For each of the high motion patches (912) the patch is segmented into sub patches (914). It is noted, that the segmenting into sub patches may not be necessary if the initial patch size is not large, such as 4×4 pixels. For each of the sub patches (916), a number of neighboring sub patches with matching motion vectors as the sub patch being processed is determined (918). It is determined if the number of neighboring sub patches with matching motion vectors (N_{match}) is greater than a threshold (920). If N_{match} is less than or equal to the threshold (No at 920) the next sub patch (926) is processed. If N_{match} is greater than the threshold (Yes at 920), it is determined which, if any, pixels from the decoded last frame should be copied to the decoded first frame (922). The determined pixels may then be copied from the decoded last frame to the corresponding portion of the decoded first frame (924) and then the next sub patch is processed (926). Once all of the sub patches are processed, the next high motion patch is processed (928). Once all of the high motion patches and the low motion patches are processed, the remaining frames of the low quality segment are decoded using the first frame enhanced with the copied portions of the last frame of the high quality segment (930).

Two specific embodiments of the decoding process described above are set out in further detail below. The first decoding embodiment is applied to HEVC encoded bitstreams and uses a patch size of 32×32 pixels for the initial segmentation. To segment the decoded first frame, SF, into high motion and low motion areas, motion estimation was conducted between the SF and the decoded last frame of the high quality segment GF at the decoder. After the motion estimate, the SF is divided into non-overlapping 32×32 pixel patches with the motion vectors (MVs) for each patch averaged and compared to a threshold Th_{MV}. Note that each patch may overlap with multiple Prediction Units (PUs). In this embodiment Th_{MV} was set to:

$${Th}_{MV} = \frac{w \times QP}{30000} , \qquad ( 1 )$$

where w is the width of the video, and QP is the (average) quantization parameter of the frame. The patches whose average motion vectors are below the threshold are designated as the low motion areas, denoted as SF_{low}, while the rest are designated as the high motion areas, denoted by SFₕᵢ.

The low motion areas SF_{low} are then partitioned into non-overlapping 16×16 pixel patches. For each 16×16 patch, the Sum of Squared Differences (SSD) is calculated between the patch's pixels and the co-located pixels in the GF. If the SSD is smaller than a threshold, Th_{SSD}, the patch in SF_{low} is replaced with the patch from the GF.

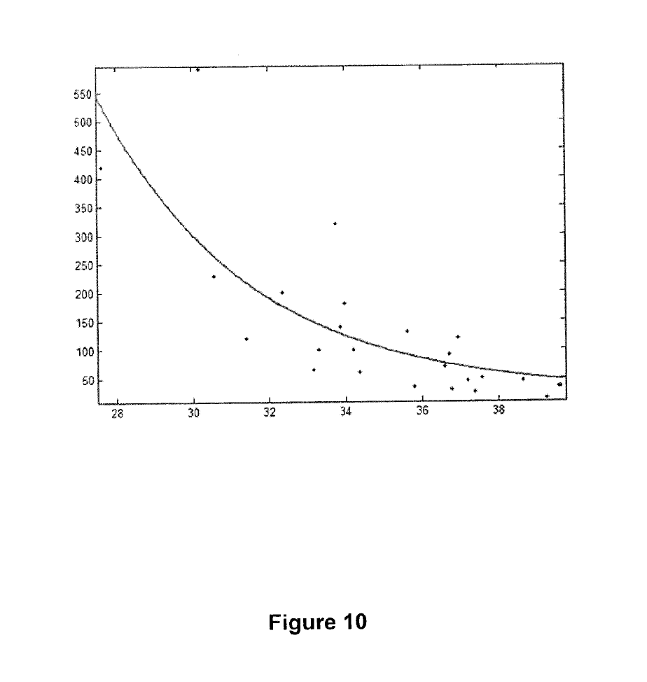

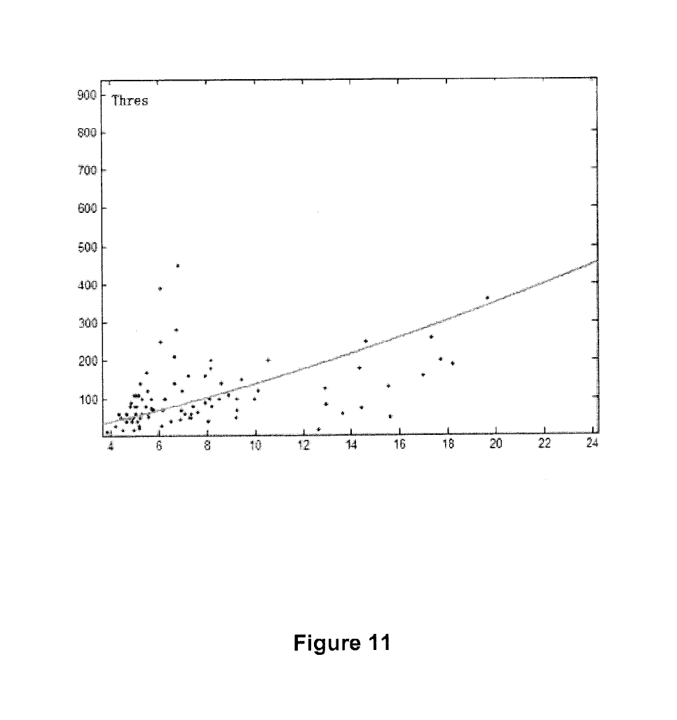

The performance of the decoding depends on the value of Th_{SSD}. All integer values between 10 and 600 were exhaustively tested for Th_{SSD} and found the threshold value Th_{Opt} that provided the largest average peak signal to noise ratio (PSNR) gain over all frames after (and including) the SF in display order. The relationship between the values of Th_{Opt} and the PSNR of the SF after intra encoding was plotted as depicted in FIG. 10. The relationship between the values of Th_{Opt} and the average, with regard to the number of motion vectors in the bitstream, rate-distortion (RD) cost for the motion vectors (MECost) between the decoded GF and SF was plotted as depicted in FIG. 11. MECost may be calculated by the decoder as:

$$MECost = \frac{{Σ}_{∀ mv} \{ SAD ( mv ) + {λ}_{ME} Bits ( mv ) \}}{{Σ}_{∀ mv} 1} \qquad ( 2 )$$

Where SAD(mv) is the Sum of Absolute Differences for my. The relationship between Th_{Opt} and the PSNR as shown in FIG. 10, and MECost as shown in FIG. 11, were data fitted using a Laplacian and a power function respectively. The best fit for the Laplacian function was:

Th₁=1.112×e^{(-0.2963×PSNR+15.14)}−10.21, (3)

For the power function, the best fit was:

Th₂=6.213×MECost^{1.348}, (4)

From the two data fittings, the threshold Th_{SSD} can be defined as:

Th_{SSD}=max(Th₁,Th₂), (5)

Accordingly, the threshold Th_{SSD} can be calculated given the PSNR and the MECost, which in turn can be calculated from the motion vectors calculated for the decoded first frame. The threshold Th_{SSD} is set as the one of the two thresholds Th₁ and Th₂ that leads to a larger number of patches designated as “matched” in order to maximize the enhancement to the first frame provided by GF. Further, the threshold is determined based on the temporal similarity between GF and SF before encoding, represented by MECost in (4), as well as the loss of fidelity after encoding, represented by PSNR in (3).

As set out above, in order to determine the threshold Th_{SSD} the PSNR should be known. The PSNR value for the SF after intra-frame encoding can be embedded into the HEVC bitstream, for example in SEI information or user data, by the encoder using 16 bits. Alternatively, the PSNR could be estimated at the decoder without requiring the encoder to embed the additional information.

The following is a pseudo code listing for combining the low motion areas of the first frame with corresponding areas of the decoded last frame.

For each pixel 16x16 patch P∈SF_{low} do

```
  Calculate SSD(P,P′) between P and co-located patch
P′ in GF.
  If SSD(P,P′)<Th_{SSD} then
```

Copy P′ to P

End if

End for

The high motion areas of the decoded first frame may be enhanced from the GF. Motion information may be used in the enhancement of the high motion areas SFₕᵢ with reference to the GF. The motion vectors previously calculated by the decoder motion estimation process between the GF and the SF for the motion area segmentation and the calculations of the MECost and Th_{SSD} may be used for the motion information when processing the high motion areas. After the motion estimation, the motion vector MV(P) for each 4×4 patch PεSFₕᵢ and its eight immediate spatially neighboring 4×4 patches. If MV(P) matched more than Th_{MV} out of the 8 MVs from the eight 4×4 neighbors, then for each pixel pεP, the difference between p and the pixel p′ in the GF referenced by MV(P) is calculated. The difference may then be compared with a threshold Th_{Y}, with p replaced by p′ if the difference is lower than Th_{Y}. In testing, Thₘᵥ was set to 6, and values of Th_{Y} between 5 and 53 were tested using a step size of 2.

The following is a pseudo code listing for combining the low motion areas of the first frame with corresponding areas of the decoded last frame.

for Each 4x4 patch P∈SFₕᵢ do

```
  Find the 8 MVs from 8 immediate spatially
neighboring 4x4 blocks of P
  if MV(P) matches more than Thₘᵥ out of 8 neighbor
MVs then
```

for Each pixel p∈P do

find pixel p′ in the GF referenced by

MV(P)

if |p − p′| < Th_{Y} then

Copy p′ to p

end if

end for

end if

end for

The decoder process described above was evaluated using an HEVC HM 8.2 encoder and the low delay configuration to encode test bitstreams. For each test clip, the HEVC encoder was ran for the first 32 frames of the clip to create the high quality segment, followed by HEVC encoding, with the same HEVC low delay configuration, of the remaining frames as the low quality segment with frame No. 33 encoded as an IDR frame SF. The QP used for encoding the first frame at the higher quality was set to be 5 levels lower than for the SF. The test clips included screen captures such as SlideEditing, video conferencing clips such as the Vidyo clips, as well as relatively higher motion clips such as the BaseketballPass and PartyScene.

The PSNR improvements for the SF, and averaged over 30 and 60 frames after (and including) the SF are given in Table 1. In the table, the values listed under the QP column are the values used for encoding the first frame of the high quality segment.

TABLE 1
PSNR Improvement

| | | | Gain-Start | Gain-30 | Gain-60 | Avg PSNR (dB) |
|---|---|---|---|---|---|---|
| | QP | Thγ | Frame (dB) | Frames (dB) | Frames | 1^{st}/30/60 |
| BasketballPass | 34 | 7 | 0.68 | 0.24 | −0.51 | 34.66/33.47/33.05 |
| | 35 | 5 | 0.56 | 0.17 | 0.02 | 34.08/32.92/32.48 |
| | 36 | 5 | 0.34 | 0.06 | 0.01 | 33.43/32.33/31.91 |
| | 38 | 13 | 0.86 | 0.29 | 0.11 | 32.16/31.22/30.81 |
| | 39 | 9 | 0.63 | 0.19 | 0.07 | 31.61/30.64/30.27 |
| | 40 | 9 | 0.38 | 0.16 | 0.06 | 31.07/30.22/29.80 |
| ChromaKey | 34 | 5 | 0.35 | −0.03 | −0.08 | 36.98/35.57/34.85 |
| | 35 | 5 | 0.23 | −0.13 | −0.16 | 36.46/35.12/34.37 |
| | 36 | 5 | 0.46 | 0.03 | −0.05 | 35.95/34.59/33.84 |
| | 38 | 5 | 0.63 | 0.05 | −0.01 | 34.97/33.60/32.81 |
| | 39 | 5 | 0.90 | 0.20 | 0.09 | 34.41/33.07/32.30 |
| | 40 | 5 | 0.78 | 0.08 | 0.01 | 34.02/32.60/31.81 |
| FourPeople | 34 | 15 | 0.96 | 0.77 | 0.59 | 37.44/36.66/36.62 |
| | 35 | 5 | 1.19 | 0.88 | 0.71 | 36.82/36.11/36.06 |
| | 36 | 5 | 1.49 | 1.16 | 0.96 | 36.23/35.55/35.48 |
| | 38 | 5 | 1.72 | 1.26 | 1.09 | 34.93/34.36/34.29 |
| | 39 | 5 | 1.84 | 1.36 | 0.78 | 34.27/33.74/33.66 |
| | 40 | 7 | 2.05 | 1.52 | 1.34 | 33.59/33.09/33.01 |
| Johnny | 34 | 5 | 0.63 | 0.36 | 0.25 | 38.90/38.17/38.13 |
| | 35 | 5 | 1.09 | 0.61 | 0.4 | 38.37/37.68/37.63 |
| | 36 | 5 | 1.08 | 0.65 | 0.51 | 37.87/37.21/37.15 |
| | 38 | 5 | 1.47 | 0.84 | 0.69 | 36.70/36.16/36.06 |
| | 39 | 5 | 1.53 | 0.89 | 0.71 | 36.19/35.66/35.58 |
| | 40 | 5 | 1.50 | 0.81 | 0.65 | 35.58/35.10/35.01 |
| SlideEditing | 34 | 27 | 2.50 | 1.93 | 1.55 | 35.96/36.26/36.24 |
| | 35 | 45 | 2.66 | 2.13 | 1.78 | 35.04/35.24/35.17 |
| | 36 | 47 | 2.67 | 2.11 | 1.75 | 34.18/34.42/34.38 |
| | 38 | 19 | 2.81 | 2.40 | 2.00 | 32.18/32.37/32.31 |
| | 39 | 23 | 2.79 | 2.38 | 1.99 | 31.23/31.44/31.40 |
| | 40 | 41 | 2.67 | 2.26 | 1.90 | 30.37/30.52/30.44 |
| KristenAndSara | 34 | 5 | 0.57 | 0.37 | 0.31 | 38.47/37.77/37.69 |
| | 35 | 5 | 0.81 | 0.54 | 0.46 | 37.90/37.25/37.16 |
| | 36 | 5 | 1.18 | 0.71 | 0.62 | 37.32/36.71/36.61 |
| | 38 | 5 | 1.40 | 0.92 | 0.8 | 36.09/35.57/35.48 |
| | 39 | 7 | 1.38 | 0.87 | 0.75 | 35.54/35.03/34.45 |
| | 40 | 7 | 1.38 | 0.92 | 0.8 | 34.95/34.45/34.35 |
| Vidyo1 | 34 | 5 | 1.11 | 0.77 | 0.62 | 38.71/38.02/38.00 |
| | 35 | 5 | 1.23 | 0.81 | 0.68 | 38.13/37.48/37.46 |
| | 36 | 5 | 1.48 | 0.95 | 0.78 | 37.59/36.94/36.91 |
| | 38 | 9 | 1.66 | 1.07 | 0.89 | 36.33/35.79/35.74 |
| | 39 | 5 | 1.80 | 1.17 | 0.98 | 35.77/35.22/35.18 |
| | 40 | 5 | 1.67 | 1.08 | 0.91 | 35.15/34.65/34.62 |
| Vidyo3 | 34 | 7 | 0.19 | 0.23 | 0.24 | 38.42/37.32/37.33 |
| | 35 | 7 | 0.42 | 0.35 | 0.38 | 37.79/36.72/36.73 |
| | 36 | 7 | 0.62 | 0.49 | 0.51 | 37.15/36.10/36.11 |
| | 38 | 7 | 0.96 | 0.67 | 0.64 | 35.87/34.89/34.89 |
| | 39 | 5 | 1.00 | 0.75 | 0.71 | 35.18/34.24/34.23 |
| | 40 | 5 | 1.04 | 0.76 | 0.71 | 34.54/33.65/33.63 |
| FlowerVase | 34 | 5 | −0.10 | −0.44 | −0.53 | 39.16/37.36/36.70 |
| | 35 | 5 | −0.05 | −0.39 | −0.49 | 38.52/36.79/36.11 |
| | 36 | 5 | 0.28 | −0.26 | −0.36 | 37.89/36.19/35.50 |
| | 38 | 5 | 0.46 | −0.07 | −0.18 | 36.52/34.99/34.30 |
| | 39 | 5 | 0.53 | −0.04 | −0.17 | 35.94/34.41/33.71 |
| | 40 | 5 | 0.56 | 0.04 | −0.10 | 35.31/33.86/33.16 |
| ChinaSpeed | 34 | 13 | −2.12 | −0.65 | −0.38 | 36.45/34.16/33.96 |
| | 35 | 29 | −1.66 | −0.63 | −0.41 | 35.70/33.50/33.31 |
| | 36 | 19 | −1.31 | −0.25 | −0.15 | 35.02/32.83/32.64 |
| | 38 | 9 | −0.71 | −0.13 | −0.01 | 33.58/31.44/32.28 |
| | 39 | 21 | −0.32 | 0.03 | 0.11 | 32.66/30.73/30.60 |
| | 40 | 11 | −0.33 | −0.20 | −0.01 | 32.10/30.07/29.96 |
| Avg Gain | | | 0.91 (dB) | 0.60 (dB) | 0.47 (dB) | |

As can be seen, the PSNR improvements were significant for most of the test clips, with an average gain (with regard to all clips and bitrates) of 0.91 dB for the SF, and in most cases, a significant gain was achieved for at least 30 to 60 frames after the SF, even though the SF was the only frame to which the enhanced processing was performed. For some clips, the initial gain for the SF was lost after some frames, showing a net loss of average PSNR after 30-60 frames. This loss of the improvement to the SF over time may have occurred because after enhancing the SF, the decoder still used the same MV and residual information in the low quality bitstream for the decoding of the remaining frames in the low quality segment, even though the SF has been modified to produce the enhanced first frame used for decoding. This may lead to mismatches between the residual information needed since the enhanced SF is used as the reference, and the residual information in the bitstream, created by the encoder using the un-enhanced SF as the reference frame.

However, even with such mismatches, for many sequences, especially for video conferencing, screen capture and video surveillance applications and some clips with higher motion, a net gain was still achieved for many frames after the SF. For clips such as SlideEditing and the Vidyo clips, an average PSNR gain of well over 1 dB was observed for the entire clip after the SF, containing hundreds of frames.

As mentioned previously, the side information that can be provided from the encoder by the decoder is the PSNR for the SF after encoding as the first IDR frame of the low quality segment. This corresponds to a total of 16 bits using natural binary representation without entropy coding, and is a negligible overhead. Therefore, the PSNR gains reported reflect the “net” gains considering both the PSNR and the bitrate.

In terms of complexity, because the proposed processing was carried out for only one frame of the low quality segment, even though the decoding process involves motion estimation and calculations of SAD/SSD, the increase to the complexity of the decoding of SF is still reasonable, and lower than that for HEVC encoding of a similar frame. This is because processing required for the HEVC encoding for transform, quantization, the bulk of the processing for mode decision, and the deblocking filter are not necessary for enhanced decoding. Averaged for all frames in the low quality segment, the increase is modest considering the potential gain in PSNR and subjective quality achieved.

Finally, the clips for which a PSNR gain was not achieved in Table 1 were analyzed. In one of the clips subjective quality improvements were achieved even though the subjective quality improvements were not reflected in the PSNR. This might have been due to small mis-alignments of some pixels that might not be visible, but still have caused the PSNR to degrade. On the other hand, another clip was a case where although visible subjective improvements were achieved for both static as well as moving areas, some relatively large mis-aligned/matched patches led to an overall PSNR loss. Such mis-alignments may be visually similar to artifacts created by erroneously received motion vectors when video bitstreams are sent over error prone networks. Therefore, techniques developed for error concealment of such artifacts may be helpful in remedying such PSNR losses while preserving the gain in other areas.

In the current implementation, the value for Th_{Y} for higher motion areas was selected from the range between 5 and 53 based on the clip and bitrate. The values used for the different test clips are listed in Table 1. The value for most clips was around 5. It may be possible to determine the value for Th_{Y} by estimating the decoded PSNR.

The second decoding embodiment is applied to H.264/AVC encoded bitstreams. To segment the decoded first frame SF into high and low motion areas, motion estimation (ME) is conducted at the decoder between the SF and the decoded last frame of the high quality segment GF, with the SF divided into non-overlapping 4×4 patches with the average motion vector (MV) for each patch compared to a threshold Th_{MV}. In this embodiment, Th_{MV} is set to:

$${Th}_{MV} = \frac{w \times QP}{30000} , \qquad ( 1 )$$

where w is the width of the video, and QP is the (average) quantization parameter of the frame. The patches whose average motion vectors are below the threshold are designated as the low motion areas, denoted as SF_{low}, while the rest are designated as the high motion areas, denoted by SFₕᵢ.

The patch size used for the initial segmentation may be determined based on the video. Two signatures of the video may be used to determine the patch size. First, Th_{MSD} may be compared to a threshold Th_{MSD0}=0.0377e0.2272*QP. Patches of size 32×32 were used If Th_{MSD}<Th_{MSD0}. Otherwise, a parameter P_{T} was calculated at the encoder, defined as the percentage of 4×4 MVs found by the decoder between GF and SF, which led to a higher MSE than the MSE calculated with the 4×4 MVs obtained by the encoder for the same patch using the GF and the encoded input for the SF. The parameter P_{T} calculated at the encoder may be included in the encoded bitstream or may be provided to the decoder using other channels. Then, based on the value of P_{T}, different patch sizes were used. For example for P_{T} between [0, 0.3%), [0.3%, 0.8%), [0.8%, 2%) and [2%, 100%), patches of 32×32, 16×16, 8×8 and 4×4 were used relatively.

The low motion areas SF_{low} may then be partitioned into non-overlapping patches. In this embodiment, the patch sizes used may be determined based on the frame.

For the parts where the motion is subtle and complex, the patch size should be small, while for parts where the scale of objects and motion is large, the patch size should be relatively larger. To assess the scale and complexity of motion, the variance of MVs is used to determine the patch size. First the frame is divided into 128×128 non-overlapping patches. For each patch, the variance of MVs in the patch is calculated and compared to a threshold Th_{V}. If variance<Th_{V}, the patch is divided into four smaller 64×64 patches and the average of MV variance in each patch is calculated. If variance<Th_{V}, the patches are again divided. Since the average of MV variance in each patch will decrease with each division, when variance>Th_{V}, the division of the patch size is considered proper. The following is a pseudo code listing for determining the size of the patches.

for Each 128x128 patch P do

for Size = 128; Size>2; Size = Size/2 do

Va = 0;
for Each Size x Size patch P′ in P do

Va = Va + variance of MVs in P′;

end for
Va = Va/(128/Size)2
if Va > Th_{V} then

break;

end if

end for
Divide P into Size × Size Patches;

end for

Once the frame has been segmented into patches, for each patch, the Mean Square Differences (MSD) between its pixels and their counterpart in the GF without motion compensation since it was a low motion patch is calculated. If the MSD is smaller than a threshold Th_{MSD} the patch in SF_{low} is replaced with the patch in the GF.

The performance of the second embodiment depends on the value of Th_{MSD}. The value of Th_{MSD} was exhaustively tested with integer values between 10 and 700 and found the threshold Th_{Opt} that provided the largest average PSNR gain over all frames after (and including) the SF in display order.

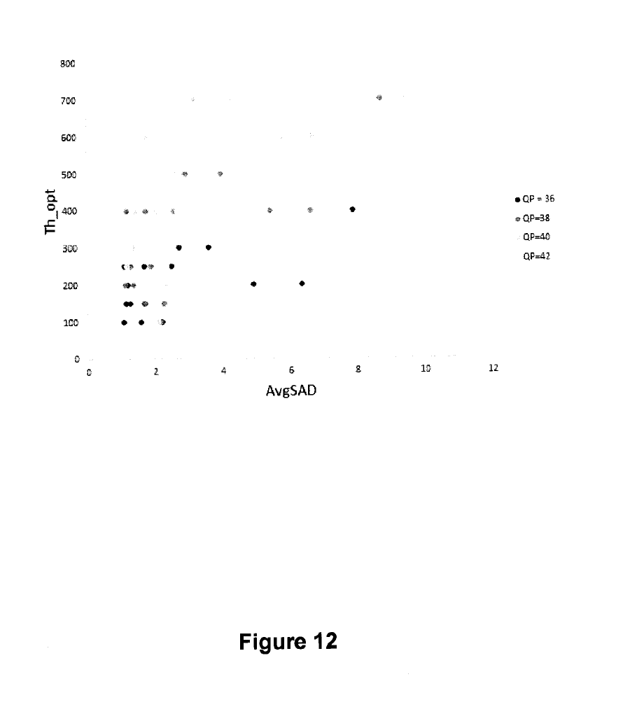

FIG. 12 is a plot of the relationship between the values of Th_{MSD} and the Average Sum of Absolute Differences (AvgSAD) between the decoded GF and SF referenced by the calculated MVs (AvgSAD) with different QP values of the decoded SF.

Th_{OPT} was data fitted with AvgSAD and QP using a linear function. The best fittings were found to be:

Th_{MSD}=−1852+54.39×QP+38.12×AvgSAD (2)

The reasoning behind using Th_{MSD} is that the threshold Th_{MSD} that leads to a larger number of patches designated as “matched” should be used to maximize the benefit of the presence of the GF, and the value of the thresholds should be determined by the temporal similarity between GF and SF before encoding, hence the AvgSAD in equation (2), as well as the loss of fidelity after encoding, roughly represented by QP in (2).

The following is a pseudo code listing for combining the low motion areas of the first frame with corresponding areas of the decoded last frame.

For each pixel patch P∈SF_{low} do

```
  Calculate MSD(P,P′) between P and co-located patch
P′ in GF.
  If MSD(P,P′)<Th_{MSD} then
```

Copy P′ to P

End if

End for

The high motion areas can be processed to enhance the SF. Motion information was used in the enhancement of the high motion areas SFhi with reference to the GF. The motion information was provided by the MVs that were obtained in the decoder ME process between the GF and the SF for the motion area segmentation and the calculations of the MECost and Th_{MSD}. In order to improve the accuracy of the MVs after the ME, the MV(P) for each 4×4 patch PεSFₕᵢ and its eight immediate spatially neighboring 4×4 patches were compared. If MV(P) matched more than Th_{judge} out of the 8 neighbor MVs, then the MSD between P and the 4×4 patch P′ in the GF referenced by MV(P) was calculated. The MSD was then compared with Th_{MSD}, and P was replaced by P′ if the difference is lower than Th_{MSD}. Th_{judge} was set to 4 although other values may be used.

The following is a pseudo code listing for combining the high motion areas of the first frame with corresponding areas of the decoded last frame.

for Each 4x4 patch P∈SFₕᵢdo

```
  Find the 8 MVs from 8 immediate spatially
neighboring 4x4 blocks of P
  if MV(P) matches more than Th_{judge}out of 8 neighbor
MVs then
```

```
  find 4x4 patch P′in the GF referenced by
MV(P)
  if MSD(MSD(P,P′)<Th_{MSD} then
```

Copy P′ to P

end if

end if

end for

The second decoder embodiment was evaluated using the H.264x264 encoder test bitstreams. For each test clip, the x264 encoder was run for the first 10 frames of the clip to create the high quality segment, followed by x264 encoding (with the same configuration) of the remaining frames as the low quality segment with frame No. 11 encoded as an IDR frame used as the SF. The QP used for encoding the first frame of the test clip was set to be 5 levels lower than for the SF and ipratio and pbratio were set to 1. The test clips included screen captures such as SlideEditing, video conferencing clips such as the Vidyo clips, as well as relatively higher motion clips such as the Baseketball Pass and PartyScene.

The PSNR improvements for the SF, and averaged over 30 and 60 frames after (and including) the SF are given in Table 2. In the table, the values listed under the QP column are the values used for encoding the first frame of the low quality segment, that is the 11^{th} frame of the video.

As can be seen, the PSNR improvements were significant for most of the test clips, with an average gain (with regard to all clips and bitrates) of 0.49 dB for the SF, and in most cases, a significant gain was achieved for at least 30 to 60 frames after the SF, even though the SF was the only frame to which the enhanced processing was performed. For some clips, the initial gain for the SF was lost after some frames, showing a net loss of average PSNR after 30-60 frames. This loss of the improvement to the SF over time may have occurred because after enhancing the SF, the decoder still used the same MV and residual information in the low quality bitstream for the decoding of the remaining frames in the low quality segment, even though the SF had already been modified to produce the actual reference frame of the enhanced SF. This led to mismatches between the residual information needed for the enhanced SF that was used as the reference, and the residual information in the bitstream, created by the encoder using the un-enhanced SF as the reference frame. However, even with such mismatches, for many sequences, especially for video conferencing, screen capture and video surveillance applications and some clips with higher motion, a net gain was still achieved for many frames after the SF. For clips such as SlideEditing, KristenAndSara and FourPeople, an average PSNR gain of well over 0.5 dB for the entire clip after the SF, containing hundreds of frames was observed.

The clips for which a PSNR gain was not achieved in Table 2 were analyzed. Subjective quality improvements were achieved, but were not reflected in the PSNR. This might have been due to slow-motion movements of objects with complex texture (such as leaves). Since in the disclosed decoder the slow motion patches were copied directly, the enhancement can be observed subjectively, since the motion was so small, but still results in a loss in PSNR.

Finally, in terms of complexity, because the proposed processing was carried out for only one frame of the low quality segment, even though the decoding process involves ME and calculations of SAD/MSD at the decoder, the increase to the complexity of the decoding of SF is still reasonable, and lower than that for H.264 encoding of a similar frame. This is because processing required for the H.264 encoding for transform, quantization, the bulk of the processing for mode decision, and the deblocking filter are not necessary for enhanced decoding. Averaged for all frames in the low quality segment, the increase is modest considering the potential gain in PSNR and subjective quality achieved.

Although the above has described using the decoder to improve the quality of decoded video, it may also be used to reduce the power required for encoding, as well as reducing the bandwidth required for transmitting a video. If the decoder indicates to the encoder that it is capable of the enhanced decoding described above, the encoder may vary the encoding of subsequent segments between higher and lower qualities, and the decoder may improve the decoded video quality as described above. The patch size may be fixed to reduce the computational complexity. Further, the Th_{MSD} may be estimated using Average SAD and a different fitting such as a curve fitting. The power consumption for different test clips is shown in Table 3.

TABLE 2
PSNR Improvement

| | | Gain-Start | Gain-30 | | Avg |
|---|---|---|---|---|---|
| | | Frame | Frames | Gain-60 | PSNR (dB) |
| | QP | (dB) | (dB) | Frames | 1^{st}/30/60 |
| BasketballPass | 36 | 0.26 | 0.09 | 0.00 | 32.86/32.45/32.87 |
| | 38 | 0.18 | 0.07 | 0.02 | 31.59/31.23/31.67 |
| | 40 | 0.07 | 0.04 | 0.01 | 30.62/30.24/30.67 |
| | 42 | 0.07 | 0.03 | 0.00 | 29.56/29.17/29.56 |
| BQSquare | 36 | 0.14 | −0.20 | −0.30 | 29.85/28.94/28.81 |
| | 38 | 0.30 | −0.10 | −0.20 | 28.36/27.53/27.39 |
| | 40 | 0.37 | 0.00 | −0.10 | 26.88/26.25/26.10 |
| | 42 | 0.39 | 0.11 | 0.03 | 25.44/24.99/24.84 |
| Cactus | 36 | 0.32 | 0.12 | 0.08 | 33.32/32.92/32.89 |
| | 38 | 0.25 | 0.06 | 0.02 | 32.27/31.92/31.88 |
| | 40 | 0.19 | 0.01 | 0.00 | 31.34/30.98/30.93 |
| | 42 | 0.14 | 0.00 | 0.00 | 30.35/29.99/29.93 |
| ChinaSpeed | 36 | 0.78 | 0.59 | 0.54 | 33.53/32.97/32.91 |
| | 38 | 0.84 | 0.65 | 0.58 | 32.00/31.52/31.44 |
| | 40 | 0.73 | 0.47 | 0.39 | 30.59/30.08/30.03 |
| | 42 | 0.62 | 0.49 | 0.45 | 29.09/28.62/28.58 |
| Chromakey | 36 | 0.15 | 0.06 | 0.02 | 35.34/35.03/35.06 |
| | 38 | 0.16 | 0.06 | 0.02 | 34.30/34.03/34.05 |
| | 40 | 0.14 | 0.07 | 0.05 | 33.42/33.10/33.08 |
| | 42 | 0.18 | 0.05 | 0.03 | 32.55/32.15/32.16 |
| FlowerVase | 36 | 0.47 | 0.14 | −0.06 | 37.41/36.53/36.15 |
| | 38 | 0.64 | 0.12 | −0.08 | 36.12/35.32/34.85 |
| | 40 | 0.69 | 0.21 | 0.004 | 34.92/34.03/33.52 |
| | 42 | 0.48 | 0.15 | 0.001 | 33.73/32.69/32.16 |
| FourPeople | 36 | 1.06 | 0.73 | 0.62 | 35.42/35.37/35.37 |
| | 38 | 1.02 | 0.77 | 0.67 | 34.12/34.12/34.12 |
| | 40 | 0.89 | 0.65 | 0.56 | 32.95/32.98/32.98 |
| | 42 | 0.83 | 0.62 | 0.55 | 31.70/31.76/31.76 |
| Johnny | 36 | 0.38 | 0.25 | 0.21 | 36.83/36.53/36.44 |
| | 38 | 0.40 | 0.27 | 0.23 | 35.70/35.42/35.33 |
| | 40 | 0.38 | 0.28 | 0.25 | 34.88/34.58/34.51 |
| | 42 | 0.41 | 0.24 | 0.22 | 33.78/33.45/33.39 |
| KristenAndSara | 36 | 0.83 | 0.63 | 0.58 | 36.73/36.43/36.39 |
| | 38 | 0.92 | 0.67 | 0.62 | 35.48/35.23/35.19 |
| | 40 | 0.84 | 0.63 | 0.59 | 34.30/34.07/34.02 |
| | 42 | 0.77 | 0.58 | 0.54 | 32.92/32.75/32.71 |
| SlideEditing | 36 | 2.21 | 2.14 | 2.12 | 31.81/31.83/31.82 |
| | 38 | 1.99 | 1.94 | 1.88 | 29.41/29.88/29.87 |
| | 40 | 1.95 | 1.95 | 1.92 | 28.20/28.21/28.20 |
| | 42 | 1.88 | 1.79 | 1.76 | 26.30/26.24/26.23 |
| ParkScene | 36 | −0.56 | −0.55 | −0.52 | 33.43/32.94/32.68 |
| | 38 | −0.40 | −0.45 | −0.45 | 32.34/31.92/31.64 |
| | 40 | −0.27 | −0.32 | −0.31 | 31.45/30.99/30.70 |
| | 42 | 0.17 | −0.22 | −0.23 | 30.54/30.07/29.75 |
| PartyScene | 36 | 0.26 | −0.15 | −0.28 | 29.12/28.48/28.47 |
| | 38 | 0.32 | −0.06 | −0.18 | 27.68/27.16/27.14 |
| | 40 | 0.32 | 0.03 | −0.06 | 26.37/25.94/25.94 |
| | 42 | 0.32 | 0.09 | 0.03 | 25.11/24.80/24.81 |
| Vidyo1 | 36 | 0.43 | 0.25 | 0.19 | 36.91/36.78/36.72 |
| | 38 | 0.42 | 0.24 | 0.19 | 35.73/35.66/35.63 |
| | 40 | 0.38 | 0.22 | 0.17 | 34.67/34.62/34.59 |
| | 42 | 0.35 | 0.18 | 0.15 | 33.39/33.39/33.37 |
| Vidyo3 | 36 | 0.13 | 0.05 | 0.02 | 36.39/36.01/35.96 |
| | 38 | 0.12 | 0.05 | 0.04 | 35.07/34.78/34.73 |
| | 40 | 0.15 | 0.11 | 0.11 | 33.74/33.47/33.41 |
| | 42 | 0.08 | 0.09 | 0.08 | 32.56/32.30/32.26 |
| Vidyo4 | 36 | 0.35 | 0.24 | 0.16 | 37.01/36.52/36.29 |
| | 38 | 0.39 | 0.25 | 0.18 | 35.93/35.50/35.23 |
| | 40 | 0.38 | 0.26 | 0.19 | 34.84/34.47/34.21 |
| | 42 | 0.36 | 0.23 | 0.17 | 33.85/33.50/33.22 |
| Yacht | 36 | 0.66 | 0.09 | −0.10 | 31.73/31.55/31.57 |
| | 38 | 0.72 | 0.23 | 0.08 | 30.29/30.23/30.24 |
| | 40 | 0.59 | 0.28 | 0.16 | 28.95/28.98/29.01 |
| | 42 | 0.82 | 0.45 | 0.32 | 27.60/27.69/27.75 |
| Avg Gain | | 0.49 | 0.30 | 0.23 | |
| | | (dB) | (dB) | (dB) | |

TABLE 3
PSNR Gain and Power Consumption Improvement

| | | | PSNR/dB | | | | | |
|---|---|---|---|---|---|---|---|---|
| File | Ref | QP | std | enhance | gain | Time/s | Power/mW | Consumption/J |
| Johnny_1280x720 | 4(std) | 38 | 35.3867 | 35.5598 | 0.1731 | 46.19 | 1347.5 | 62.24 |
| | | 40 | 34.5062 | 34.7735 | 0.2673 | 41.2 | 1367.75 | 56.35 |
| | | 42 | 33.3732 | 33.716 | 0.3428 | 39.71 | 1380.11 | 54.80 |
| | | 44 | 32.0849 | 32.4559 | 0.371 | 38.41 | 1368.66 | 52.57 |
| | 2 | 38 | 35.3889 | 35.5671 | 0.1782 | 43.1 | 1360.92 | 58.66 |
| | | 40 | 34.498 | 34.7616 | 0.2636 | 40.81 | 1363.3 | 55.64 |
| | | 42 | 33.3615 | 33.7113 | 0.3498 | 39.01 | 1369.66 | 53.43 |
| | | 44 | 32.0865 | 32.4557 | 0.3692 | 37.82 | 1369.82 | 51.81 |
| | 1 | 38 | 35.3514 | 35.4984 | 0.147 | 39.31 | 1359.09 | 53.43 |
| | | 40 | 34.4769 | 34.7458 | 0.2689 | 36.77 | 1369.23 | 50.35 |
| | | 42 | 33.3388 | 33.6942 | 0.3554 | 35.64 | 1329.01 | 47.37 |
| | | 44 | 32.0694 | 32.4225 | 0.3531 | 34.2 | 1364.07 | 46.65 |
| KristenAndSara_1280x720 | 4(std) | 38 | 35.2206 | 35.6844 | 0.4638 | 54.86 | 1361.43 | 74.69 |
| | | 40 | 33.9721 | 34.3856 | 0.4135 | 48.06 | 1303.01 | 62.62 |
| | | 42 | 32.7561 | 33.0748 | 0.3187 | 44.75 | 1357.48 | 60.75 |
| | | 44 | 31.5574 | 31.7786 | 0.2212 | 42.31 | 1383.51 | 58.54 |
| | 2 | 38 | 35.2127 | 35.6858 | 0.4731 | 47.79 | 1361.43 | 65.06 |
| | | 40 | 33.9634 | 34.3911 | 0.4277 | 45.09 | 1358.92 | 61.27 |
| | | 42 | 32.7729 | 33.0999 | 0.327 | 42.84 | 1365.45 | 58.50 |
| | | 44 | 31.555 | 31.7897 | 0.2347 | 42.98 | 1366.66 | 58.74 |
| | 1 | 38 | 35.1496 | 35.6025 | 0.4529 | 43.45 | 1361.88 | 59.17 |
| | | 40 | 33.9137 | 34.316 | 0.4023 | 41.25 | 1362.48 | 56.20 |
| | | 42 | 32.7155 | 33.0195 | 0.304 | 39.94 | 1390.16 | 55.52 |
| | | 44 | 31.5378 | 31.7608 | 0.223 | 36.63 | 1356.89 | 49.70 |
| Vidyo1_1280x720 | 4(std) | 38 | 35.6191 | 36.0726 | 0.4535 | 52.62 | 1348.1 | 70.94 |
| | | 40 | 34.5778 | 34.9125 | 0.3347 | 46.97 | 1347.1 | 63.27 |
| | | 42 | 33.3156 | 33.6889 | 0.3733 | 45.57 | 1338 | 60.97 |
| | | 44 | 32.0639 | 32.4018 | 0.3379 | 42.26 | 1350 | 57.05 |
| | 2 | 38 | 35.6353 | 36.065 | 0.4297 | 47.18 | 1353.6 | 63.86 |
| | | 40 | 34.5944 | 34.9082 | 0.3138 | 44.98 | 1348.7 | 60.66 |
| | | 42 | 33.3377 | 33.7139 | 0.3762 | 42.98 | 1360.2 | 58.46 |
| | | 44 | 32.0635 | 32.3965 | 0.333 | 40.84 | 1334.7 | 54.51 |
| | 1 | 38 | 35.5585 | 35.9914 | 0.4329 | 43.83 | 1341.8 | 58.81 |
| | | 40 | 34.5077 | 34.8237 | 0.316 | 40.63 | 1340.9 | 54.48 |
| | | 42 | 33.2424 | 33.6121 | 0.3697 | 37.92 | 1338.9 | 50.77 |
| | | 44 | 32.0038 | 32.3308 | 0.327 | 36.47 | 1364.8 | 49.77 |
| Vidyo3_1280x720 | 4(std) | 38 | 34.7181 | 34.7398 | 0.0217 | 56.24 | 1373.71 | 77.26 |
| | | 40 | 33.4533 | 33.7001 | 0.2468 | 53.24 | 1345.35 | 71.63 |
| | | 42 | 32.2449 | 32.5367 | 0.2918 | 48.7 | 1399.89 | 68.17 |
| | | 44 | 30.8634 | 31.1099 | 0.2465 | 47.13 | 1380.33 | 65.05 |
| | 2 | 38 | 34.7145 | 34.76 | 0.0455 | 51.42 | 1391.71 | 71.56 |
| | | 40 | 33.447 | 33.6954 | 0.2484 | 50.16 | 1379.91 | 69.22 |
| | | 42 | 32.2441 | 32.5356 | 0.2915 | 47.23 | 1379.27 | 65.14 |
| | | 44 | 30.8607 | 31.0883 | 0.2276 | 46.24 | 1315.49 | 60.83 |
| | 1 | 38 | 34.6368 | 34.6966 | 0.0598 | 45.16 | 1373.21 | 62.01 |
| | | 40 | 33.3875 | 33.6484 | 0.2609 | 43.26 | 1372.89 | 59.39 |
| | | 42 | 32.1585 | 32.4473 | 0.2888 | 41.06 | 1322.91 | 54.32 |
| | | 44 | 30.8047 | 31.0406 | 0.2359 | 39.58 | 1387.35 | 54.91 |
| Traffic_2560x1600 | 4(std) | 38 | 33.0161 | 32.7463 | −0.2698 | 394.55 | 1334.09 | 526.37 |
| | | 40 | 31.9826 | 31.8748 | −0.1078 | 371.71 | 1353.96 | 503.28 |
| | | 42 | 30.9063 | 30.9425 | 0.0362 | 354.01 | 1330.14 | 470.88 |
| | | 44 | 29.7929 | 29.8512 | 0.0583 | 336.93 | 1240.41 | 417.96 |
| | 2 | 38 | 32.9947 | 32.7362 | −0.2585 | 373.12 | 1169.16 | 436.24 |
| | | 40 | 31.9554 | 31.8478 | −0.1076 | 351.08 | 1210.55 | 425.00 |
| | | 42 | 30.8845 | 30.9327 | 0.0482 | 313.65 | 1213.44 | 380.60 |
| | | 44 | 29.7723 | 29.8588 | 0.0865 | 290.84 | 1160.95 | 337.65 |
| | 1 | 38 | 32.8936 | 32.6229 | −0.2707 | 290.43 | 1167.33 | 339.03 |
| | | 40 | 31.8543 | 31.7473 | −0.107 | 265.51 | 1168.04 | 310.13 |
| | | 42 | 30.7875 | 30.8365 | 0.049 | 250.48 | 1215.36 | 304.42 |
| | | 44 | 29.6892 | 29.7526 | 0.0634 | 234.37 | 1159.58 | 271.77 |
| Vidyo4_1280x720 | 4(std) | 38 | 35.312 | 35.607 | 0.295 | 66.96 | 1339.46 | 89.69 |
| | | 40 | 34.3214 | 34.6543 | 0.3329 | 58.04 | 1314.61 | 76.30 |
| | | 42 | 33.288 | 33.6491 | 0.3611 | 53.95 | 1413.55 | 76.26 |
| | | 44 | 32.1865 | 32.4252 | 0.2387 | 50.32 | 1420.89 | 71.50 |
| | 2 | 38 | 35.3161 | 35.6098 | 0.2937 | 60.51 | 1429.02 | 86.47 |
| | | 40 | 34.3295 | 34.6561 | 0.3266 | 55.88 | 1409.38 | 78.76 |
| | | 42 | 33.3126 | 33.6595 | 0.3469 | 51.5 | 1372.45 | 70.68 |
| | | 44 | 32.1922 | 32.4281 | 0.2359 | 50.74 | 1375.76 | 69.81 |
| | 1 | 38 | 35.2459 | 35.5154 | 0.2695 | 54.77 | 1381.9 | 75.69 |
| | | 40 | 34.2516 | 34.5874 | 0.3358 | 51.18 | 1401.36 | 71.72 |
| | | 42 | 33.2303 | 33.5715 | 0.3412 | 47.82 | 1398.45 | 66.87 |
| | | 44 | 32.1099 | 32.3498 | 0.2399 | 40.83 | 1385.19 | 56.56 |
| Cactus_1920x1080 | 4(std) | 38 | 31.8746 | 31.8614 | −0.0132 | 230.8 | 1238.24 | 285.79 |
| | | 40 | 30.9256 | 30.9547 | 0.0291 | 182.23 | 1272 | 231.80 |
| | | 42 | 29.9367 | 29.9797 | 0.043 | 170.32 | 1297.93 | 221.06 |
| | | 44 | 28.9346 | 28.9421 | 0.0075 | 145.9 | 1288.03 | 187.92 |
| | 2 | 38 | 31.5891 | 31.8487 | −0.0104 | 189.64 | 1318.93 | 250.12 |
| | | 40 | 30.9215 | 30.9145 | 0.002 | 162.53 | 1329.29 | 216.05 |
| | | 42 | 29.9369 | 29.9646 | 0.0277 | 147.38 | 1293.58 | 190.65 |
| | | 44 | 28.9308 | 28.949 | 0.0182 | 139.92 | 1296.75 | 181.44 |
| | 1 | 38 | 31.8238 | 31.7966 | −0.0272 | 155 | 1321.69 | 204.86 |
| | | 40 | 30.8766 | 30.85 | −0.0266 | 139.17 | 1241.3 | 172.75 |
| | | 42 | 29.8978 | 29.9309 | 0.0331 | 136.28 | 1231.98 | 167.89 |
| | | 44 | 28.8859 | 28.8753 | −0.0106 | 121.21 | 1218.88 | 147.74 |
| BasketballDrill_832x480 | 4(std) | 38 | 31.4507 | 31.5039 | 0.0532 | 42.57 | 1397.12 | 59.48 |
| | | 40 | 30.528 | 30.5834 | 0.0554 | 36.07 | 1420.23 | 51.23 |
| | | 42 | 29.5532 | 29.5904 | 0.0372 | 35.32 | 1446.6 | 51.09 |
| | | 44 | 28.5351 | 28.5766 | 0.0415 | 30.39 | 1435.37 | 43.62 |
| | 2 | 38 | 31.4447 | 31.4738 | 0.0291 | 36.35 | 1425.87 | 51.83 |
| | | 40 | 30.4941 | 30.5332 | 0.0391 | 33.85 | 1430.66 | 48.43 |
| | | 42 | 29.5271 | 29.5373 | 0.0102 | 32.48 | 1436.06 | 46.64 |
| | | 44 | 28.5339 | 28.5658 | 0.0319 | 29.77 | 1425.45 | 42.44 |
| | 1 | 38 | 31.3586 | 31.3744 | 0.0158 | 33.80 | 1443.41 | 48.79 |
| | | 40 | 30.4364 | 30.4505 | 0.0141 | 32.68 | 1422.38 | 46.48 |
| | | 42 | 29.4555 | 29.3801 | −0.0754 | 29.41 | 1418.39 | 41.71 |
| | | 44 | 28.4783 | 28.4895 | 0.0112 | 25.66 | 1433.48 | 36.78 |
| BQTerrace_1920x1080 | 4(std) | 38 | 30.0367 | 29.8197 | −0.217 | 179.36 | 1305.81 | 234.21 |
| | | 40 | 28.9869 | 28.9325 | −0.0544 | 151.5 | 1412.22 | 213.95 |
| | | 42 | 27.9082 | 27.904 | −0.0042 | 138.43 | 1421.28 | 196.75 |
| | | 44 | 26.9746 | 27.0138 | 0.0392 | 133.89 | 1418.08 | 189.87 |
| | 2 | 38 | 30.0161 | 29.811 | −0.2051 | 154.03 | 1404.16 | 216.28 |
| | | 40 | 28.9952 | 28.9366 | −0.0586 | 147.86 | 1435.3 | 212.22 |
| | | 42 | 27.912 | 27.9053 | −0.0067 | 134.3 | 1424.1 | 191.26 |
| | | 44 | 26.9635 | 26.9992 | 0.0357 | 132.47 | 1400.11 | 185.47 |
| | 1 | 38 | 29.9366 | 29.7218 | −0.2418 | 139.45 | 1385.45 | 193.20 |
| | | 40 | 28.9194 | 28.8561 | −0.0633 | 135.46 | 1400.09 | 189.66 |
| | | 42 | 27.8661 | 27.8665 | 0.0004 | 122.49 | 1390.62 | 170.34 |
| | | 44 | 26.9442 | 26.9808 | 0.0366 | 114.28 | 1394.42 | 159.35 |
| BQMall_832x480 | 4(std) | 38 | 30.159 | 30.2196 | 0.0606 | 43.86 | 1384.77 | 60.74 |
| | | 40 | 29.013 | 29.1104 | 0.0974 | 36.00 | 1405.07 | 50.58 |
| | | 42 | 27.8284 | 27.8553 | 0.0269 | 33.41 | 1366.02 | 45.64 |
| | | 44 | 26.7664 | 26.8129 | 0.0465 | 31.25 | 1419.36 | 44.36 |
| | 2 | 38 | 30.1559 | 30.04 | −0.1159 | 37.11 | 1419.42 | 52.67 |
| | | 40 | 28.9959 | 29.0706 | 0.0747 | 35.91 | 1424.37 | 51.15 |
| | | 42 | 27.8093 | 27.8729 | 0.0636 | 32.39 | 1431.37 | 46.36 |
| | | 44 | 26.7616 | 26.8001 | 0.0385 | 29.81 | 1429.74 | 42.62 |
| | 1 | 38 | 30.1197 | 30.185 | 0.0653 | 32.43 | 1417.42 | 45.97 |
| | | 40 | 28.9602 | 29.0399 | 0.0797 | 30.71 | 1442.27 | 44.29 |
| | | 42 | 27.7668 | 27.8416 | 0.0748 | 28.03 | 1444.09 | 40.48 |
| | | 44 | 26.7138 | 26.7477 | 0.0339 | 26.44 | 1441.98 | 38.13 [t] |

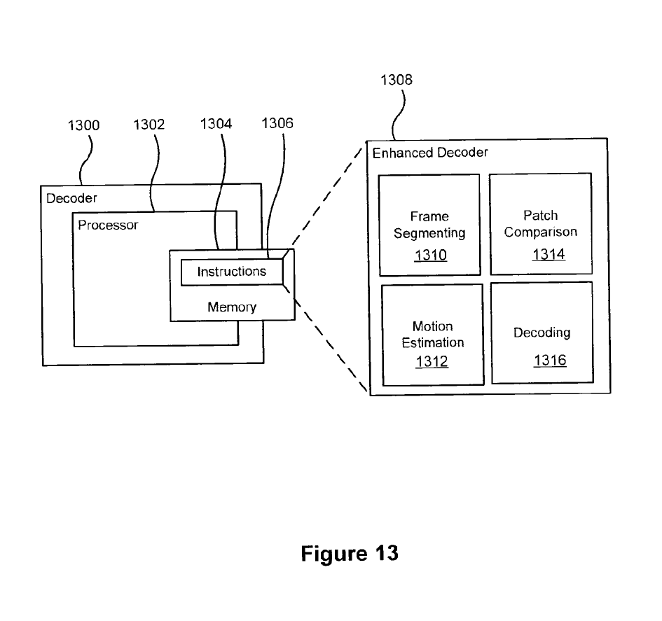

FIG. 13 depicts an apparatus for decoding video. The apparatus 1300 may comprise a processor 1302 and memory 1304. The memory 1304 may include both memory internal to the processor 1302 as well as memory external to the processor 1302. The memory stores instructions 1306 for execution by the processor, which when executed configure the apparatus 1300 to provide an enhanced decoder in accordance with the current disclosure. The enhanced decoder 1308 may include frame segmenting functionality 1310 for segmenting a decoded frame, or portions thereof, into patches. The enhanced decoder 1308 may further comprise motion estimation functionality 1312 for generating motion vectors between two decoded frames or portions thereof. The enhanced decoder 1308 may further comprise patch comparison functionality 1314 for comparing patches, either to each other or to another criteria such as a threshold. The enhanced decoder 1308 may further comprise decoding functionality 1316 for decoding segments of video. The decoding functionality 1316 may utilize other functionality of the enhanced decoder, such as the frame segmenting functionality 1310, motion estimation functionality 1312, and patch comparison functionality 1314 in order to generate an enhanced starting frame used to improve the decoding of subsequent frames of the segment.

The above has described decoding video segments using various specific examples. For the sake of clarity of the description, the above has described decoding frames based on using a specific single frame, in particular the last frame of the high quality segment, for the enhancement of a single frame, in particular the first frame of the low quality segment, it is appreciated that in some cases, and especially when the video clip contains multiple scenes, the frame of the high quality segment that is used to enhance the frame of the low quality may not be temporally immediately neighboring the frame being enhanced, but rather a frame in the high quality segment that is deemed to be the most “similar” to the frame being enhanced. The similarity may be determined in various ways, such as with regard to the Sum of Absolute Differences. Accordingly, it is possible to enhance a decoded frame of a low quality segment by combining it with at least a portion of a decoded frame of a high quality segment. Further, a group of several decoded frames of the high quality segment may used to enhance one or more decoded frames of a low quality segment. Further, the above has described combining the decoded frame of the high quality segment with the decoded frame of the low quality segment by copying a portion of the decoded high quality frame to the decoded low quality frame; however, the portion of the decoded high quality frame may be processed prior to copying. Additionally or alternatively, the entire high quality frame or frames used in enhancing the decoded low quality frame or frames may be processed prior to combining. The processing may adjust one or more image characteristics of the decoded frame, such as colour, brightness, etc using different techniques such as using histogram equalization.

Although specific embodiments are described herein, it will be appreciated that modifications may be made to the embodiments without departing from the scope of the current teachings. Accordingly, the scope of the appended claims should not be limited by the specific embodiments set forth, but should be given the broadest interpretation consistent with the teachings of the description as a whole.

The system and methods described herein have been described with reference to various examples. It will be appreciated that components from the various examples may be combined together, or components of the examples removed or modified. As described the system may be implemented in one or more hardware components including a processing unit and a memory unit that are configured to provide the functionality as described herein. Furthermore, a computer readable memory, such as for example electronic memory devices, magnetic memory devices and/or optical memory devices, may store computer readable instructions for configuring one or more hardware components to provide the functionality described herein.

What is claimed is:

1. A method of decoding a variable quality video bitstream comprising:
decoding a current frame of a current segment of the video bitstream having a first video quality;
combining the decoded current frame and a decoded previous frame of a temporally previous segment of the video bitstream into an enhanced current frame, the temporally previous segment of the video bitstream having a second video quality higher than the first video quality; and
decoding remaining frames of the current segment of the video bitstream using the enhanced current frame.

2. The method of claim 1, wherein combining the decoded current frame and the decoded previous frame comprises:
segmenting the decoded current frame into a plurality of non-overlapping patches; and
for each patch:
calculating a difference between at least a portion of the patch and a corresponding portion of the decoded previous frame; and
copying the corresponding portion of the decoded previous frame to the patch of the current frame when the difference is less than a threshold.

3. The method of claim 1, wherein combining the decoded current frame and the decoded previous frame comprises:
identifying high motion areas and low motion areas between the previous frame and the current frame;
copying at least a first portion of the decoded previous frame to at least a co-located portion of the low motion areas of the decoded current frame according to a first combination process; and
copying at least a second portion of the decoded previous frame to at least a corresponding portion of the high motion areas of the decoded current frame according to a second combination process.

4. The method of claim 3, wherein identifying high motion areas and low motion areas comprises:
determining motion vectors between the decoded previous frame and the decoded current frame using motion estimation;
segmenting the decoded current frame into a plurality of non-overlapping patches; and
marking each of the plurality of patches as either a low motion patch or a high motion patch based on the motion vectors of the patch.

5. The method of claim 4, wherein marking each of the plurality of patches comprises for each patch:
averaging together the motion vectors of the respective patch to provide a patch motion vector;
marking the patch as a low motion patch if the patch motion vector is less than a motion vector threshold; and
marking the patch as a high motion patch if the patch motion vector is greater than or equal to the motion vector threshold.

6. The method of claim 3, wherein the first combination process comprises:
determining a difference between at least the first portion of the decoded previous frame and at least the co-located portion of the low motion areas of the current frame;
copying at least the first portion of the decoded previous frame to at least the co-located portion of the low motion areas of the decoded current frame when the difference is below a threshold.

7. The method of claim 6, further comprising:
segmenting the low motion areas of the decoded current frame into a plurality of non-overlapping pixel patches; and
for each pixel patch:
determining a difference between the pixel patch and a co-located pixel patch in the decoded previous frame; and
copying the co-located pixel patch from the decoded previous frame to the pixel patch of the decoded current frame when the determined difference is below a threshold.

8. The method of claim 7, wherein the difference is determined using one of:
a mean square difference; and
a sum of squared differences.

9. The method of claim 3, wherein the second combination process comprises:
determining a difference between at least the second corresponding portion of the decoded previous frame and at least the corresponding portion of the high motion areas of the current frame;
copying at least the first corresponding portion of the decoded previous frame to at least the portion of the low motion areas of the decoded current frame when the difference is below a threshold.

10. The method of claim 9, wherein the second combination process further comprises:
segmenting the high motion areas of the current frame into a plurality of patches; and
for each patch:
determining a number (N_{match}) of neighboring patches having matching motion vectors to the current patch;
when N_{match} is more than a threshold, for each pixel p of the current patch:
determine a corresponding pixel p′ in the decoded previous frame referenced by the motion vector of the current patch; and
copying the pixel p′ to p if |p−p′| is less than a threshold.

11. The method of claim 9, wherein the second combination process further comprises:
segmenting the high motion areas of the current frame into a plurality of patches; and
for each patch:
determining a number (N_{match}) of neighboring patches having matching motion vectors to the current patch;
when N_{match} is more than a threshold, determining a corresponding pixel patch P′ in the decoded previous frame referenced by the motion vector of the current patch; and
copying the pixel patch P′ to the current patch P if the mean square differences (MSD) between P and P′ is less than a threshold.

12. The method of claim 2, wherein the segmenting uses a patch size based on the video.

13. The method of claim 12, further comprising determining the patch size by:
reducing a patch size from a starting patch size and determining a variance of motion vectors of the patch size until the variance is larger than a threshold value.

14. The method of claim 1, wherein combining the decoded current frame and the decoded previous frame comprises copying at least a portion of the decoded previous frame to the decoded current frame.

15. The method of claim 14, wherein at least the portion of the decoded previous frame copied to the decoded current frame is processed to adjust at least one image characteristic prior to copying to the decoded current frame.

16. The method of claim 1, wherein combining the decoded current frame and the decoded previous frame comprises combining the decoded current frame, the decode previous frame and at least one other decoded frame of the temporally previous segment of the video bitstream.

17. The method of claim 1, further comprising:
decoding an additional frame of the current segment of the video bitstream; and
combining the decoded further frame with at least one decoded frame from the temporally previous segment to provide an enhanced additional frame.

18. The method of claim 1, wherein the decoded previous frame combined with the decoded current frame is visually similar to the decoded current frame.

19. The method of claim 18, further comprising:
determining at least one frame from a plurality of frames of the temporally previous segment to use as the decoded previous frame based on a similarity to the decoded current frame.

20. The method of claim 1, further comprising:
decoding the previous segment of the video bitstream prior to decoding the current frame of the current segment of the video bitstream.

21. The method of claim 1, wherein the variable quality video bitstream comprises a plurality of temporal video segments, including the current segment and the temporally previous segment, each having a respective video quality.

22. The method of claim 21, wherein each of the video segments comprises at least one intra-coded video frame that can be independently decoded and at least one inter-coded video frame that is decoded based on at least one other video frame of the video segment.

23. An apparatus for decoding video comprising:
a processor for executing instructions; and
a memory for storing instructions, which when executed by the processor configure the apparatus to perform the method of any one of claims 1 to 22.

24. A non-transitory computer readable medium storing executable instructions for configuring an apparatus to perform a method according to any one of claims 1 to 22.
